(19) United States
(12) Patent Application Publication
(10) Pub. No.: US 2021/0284795 A1
(43) Pub. Date: Sep. 16, 2021

(54) RESIN FILM AND DISPLAY DEVICE INCLUDING THE SAME

(71) Applicant: SAMSUNG ELECTRONICS CO., LTD., Suwon-si (KR)

(72) Inventors: Yuichiro GOTO, Yokohama-shi (JP); Toshiyuki Takahashi, Yokohama-shi (JP); Atsushi Sato, Yokohama-shi (JP); Yoshihiro Yokote, Yokohama-shi (JP)

(73) Assignee: SAMSUNG ELECTRONICS CO., LTD., Suwon-si (KR)

(21) Appl. No.: 17/195,970

(22) Filed: Mar. 9, 2021

(30) Foreign Application Priority Data
Mar. 10, 2020 (JP) 2020-041396
Feb. 3, 2021 (KR) 10-2021-0015535

(51) Int. Cl. C08G 65/00; C08K 3/36; C08K 7/26; C08J 5/18; G02F 1/1335

(52) U.S. Cl. CPC C08G 65/007; C08K 3/36; B82Y 20/00; C08J 5/18; G02F 1/133528; C08K 7/26

(57) ABSTRACT

Provided is a resin film, including: a basic substance; hollow silica particles provided in the basic substance; and a surface modifying agent including an oil repellent surface modifying agent and a lipophilic surface modifying agent.

### CROSS-REFERENCE TO RELATED APPLICATION(S)

This application is based on and claims priority under 35 U.S.C. § 119 to Japanese Patent Application No. 2020-041396, filed on Mar. 10, 2020, in the Japan Patent Office, and Korean Patent Application No. 10-2021-0015535, filed on Feb. 3, 2021, in the Korean Intellectual Property Office, the disclosures of which are incorporated by reference herein in their entireties.

### BACKGROUND

### 1. Field

The disclosure relates to a resin film, and more particularly, to a resin film arranged on a display surface of a display device.

### 2. Discussion of Related Art

A display device equipped with a liquid crystal panel may have a polarizing film on the outermost surface of the liquid crystal panel. The polarizing film may have a function of suppressing reflection. In this regard, a resin film may be arranged on the surface of the liquid crystal panel as a low refractive layer to make it difficult to reflect light that is incident from outside. The low refractive layer is easy to catch an extraneous material such as skin sebum or an oily material because the low refractive layer is located on the outermost surface of the liquid crystal panel. Hence, the low refractive layer may be preferably formed such that the extraneous material adhered to the low refractive layer can be easily wiped off.

Recently, further lower reflection is required for a low refractive layer in a display panel. To this end, the low refractive layer may contain a large amount of hollow silica particles.

In this case, however, an extraneous material adhered to the low refractive layer is easily seen, and it is difficult to wipe out and remove the extraneous material.

### SUMMARY

Provided is a resin film that makes an extraneous material adhered thereto unnoticeable and easy to wipe out.

According to an aspect of the disclosure, there is provided a resin film includes a basic substance; hollow silica particles provided in the basic substance; and a surface modifying agent including an oil repellent surface modifying agent and a lipophilic surface modifying agent.

A mass mixing ratio of the oil repellent surface modifying agent to the lipophilic surface modifying agent may be about 0.05 to about 20.

A mass mixing ratio of the oil repellent surface modifying agent to the lipophilic surface modifying agent may be about 1 to about 20.

The oil repellent surface modifying agent and the lipophilic surface modifying agent may be provided on a surface of the basic substance.

The basic substance may include a binder including a resin formed by polymerizing a monomer or oligomer.

At least one of the oil repellent surface modifying agent or the lipophilic surface modifying agent may have a reactive group to be bonded with the resin included in the basic sub stance.

At least one of the oil repellent surface modifying agent or the lipophilic surface modifying agent may have a photopolymerizer.

The photopolymerizer may include an acrylol group or a methacryloyl group.

At least a portion of the oil repellent surface modifying agent and at least a portion of the lipophilic surface modifying agent may be exposed on the surface of the basic sub stance.

The basic substance may include a fluorine resin.

An average primary particle size of the hollow silica particles may be about 35 nm to about 100 nm.

According to an aspect of the disclosure, there is provided a display device including a display panel configured to display an image; and a low refractive layer formed on a surface of the display panel, wherein the low refractive layer includes a basic substance; hollow silica particles provided in the basic substance; and a surface modifying agent provided on a surface of the basic substance, the surface modifying agent including an oil repellent surface modifying agent and a lipophilic surface modifying agent.

Amass mixing ratio of the oil repellent surface modifying agent to the lipophilic surface modifying agent may be about 0.05 to about 20.

Amass mixing ratio of the oil repellent surface modifying agent to the lipophilic surface modifying agent may be about 1 to about 20.

The basic substance may include a binder including a resin formed by polymerizing a monomer or oligomer.

At least one of the oil repellent surface modifying agent or the lipophilic surface modifying agent may have a reactive group to be bonded with the resin included in the basic sub stance.

At least one of the oil repellent surface modifying agent or the lipophilic surface modifying agent may be a fluorine compound having a photopolymerizer.

The photopolymerizer may include an acrylol group or a methacryloyl group.

The basic substance may include a fluorine resin.

An average primary particle size of the hollow silica particles may be about 35 nm to about 100 nm.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A shows a display device, according to an embodiment;

FIG. 1B is a cross-sectional view taken along line Ib-Ib of FIG. 1A;

FIG. 2 shows a low refractive layer according to an embodiment;

FIGS. 3A, 3B, and 3C show conceptual states of a surface modifying agent on a surface of a low refractive layer;

FIG. 4 is a flowchart illustrating a method of manufacturing a low refractive layer, according to an embodiment; and

FIG. 5 shows components of a coating solution according to an embodiment.

### DETAILED DESCRIPTION

Embodiments of the disclosure will now be described in detail. The disclosure is not, however, limited to the following embodiments. Various modifications will be made to the embodiments within the scope of the disclosure. Accompanying drawings are given for describing the embodiments of the disclosure, and do not show actual sizes.

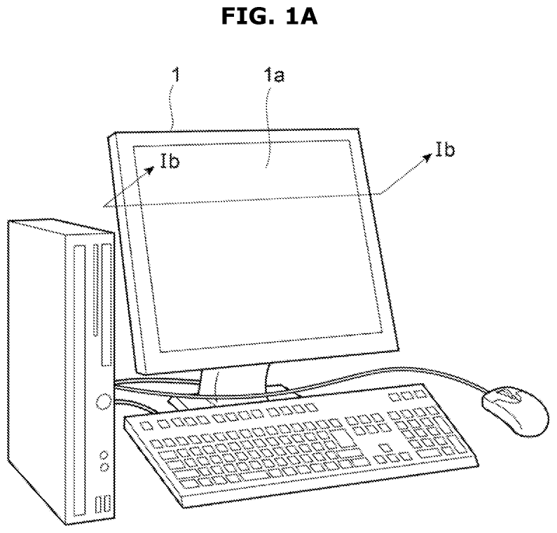

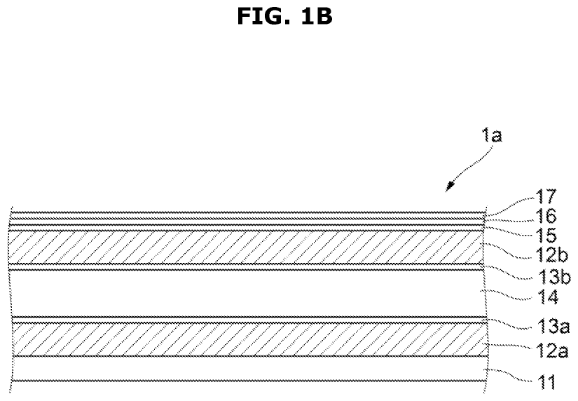

FIG. 1A shows a display device, according to an embodiment.

A display device 1 may be, for example, a liquid crystal display (LCD) for personal computer (PC), a liquid crystal television (TV), or the like. The display device 1 displays an image on a liquid crystal panel 1a.

FIG. 1B is a cross-sectional view taken along line Ib-Ib of FIG. 1A and illustrates an example of a liquid crystal panel structure, according to an embodiment.

The liquid crystal panel 1a is an example of a display panel used for displaying an image. In an embodiment, the liquid crystal panel 1a may include, for example, a vertical alignment (VA) type liquid crystal panel. The liquid crystal panel 1a may include a backlight 11 and a polarizing film 12a. The liquid crystal panel 1a further includes a phase difference film 13a, liquid crystals 14, a phase difference film 13b, and a polarizing film 12b. In addition, the liquid crystal panel 1a may further include a hard coating layer 15, a high refractive layer 16, and a low refractive layer 17. The liquid crystal panel 1a may have a structure in which the above components 11-17 are layered in the aforementioned order, but embodiments are not limited thereto. The polarizing film 12a and the polarizing film 12b may be collectively referred to as a polarizing film 12. The phase difference film 13a and the phase difference film 13b may be collectively referred to as a phase difference film 13.

The backlight 11 irradiates light onto the liquid crystals 14. The backlight 11 may include, for example, a cold cathode fluorescent lamp or white light emitting diodes (LEDs).

The polarizing films 12a and 12b are an example of polarizing means for polarizing light. The polarizing films 12a and 12b may have polarization directions perpendicular to each other. The polarizing films 12a and 12b may include a resin film, in which, for example, iodine compound molecules are contained in polyvinyl alcohol (PVA). This resin film may be adhered to a resin film formed of triacetylcellulose (TAC). The iodine compound molecules are used to polarize light.

The phase difference film 13 is used to compensate for viewing angle dependence of the liquid crystal panel 1a. Light that has passed the liquid crystals 14 is changed in a polarization state from linear polarization to elliptical polarization. For example, when black color is displayed on the liquid crystal panel 1a, black is seen when the liquid crystal panel 1a is viewed from a perpendicular direction. On the other hand, when the liquid crystal panel 1a is viewed from a diagonal direction, retardation occurs on the liquid crystals 14. Furthermore, the axis of the polarizing film 12 deviates from 90°. Accordingly, white color may occur, and contrast is degraded. In other words, viewing angle dependence occurs on the liquid crystal panel 1a. The phase difference films 13a and 13b have a function of bringing this elliptical polarization back to the linear polarization. Accordingly, the phase difference films 13a and 13b may compensate for the viewing angle dependence of the liquid crystal panel 1a.

Power is connected to the liquid crystals 14, and when the power applies a voltage, direction of alignment of the liquid crystals 14 is changed. This enables the liquid crystals 14 to control the light transmission state of the liquid crystals 14 (e.g., allowing or preventing light from passing therethrough).

As for a VA type liquid crystal panel, liquid crystal molecules are aligned in the vertical direction (e.g., vertical direction in FIG. 1B) when no voltage is applied (i.e., voltage off) to the liquid crystals 14. When the backlight 11 irradiates light, the light passes the polarizing film 12a first and is polarized. The polarized light passes the liquid crystals 14 and the polarizing film 12b blocks the polarized light because the polarization direction is different from that of the polarizing film 12b. In this case, a user who watches the liquid crystal panel 1a may not perceive the light. In other words, color of the liquid crystals 14 is black when no voltage is applied to the liquid crystals 14.

By contrast, when a maximum voltage is applied to the liquid crystals 14, the liquid crystal molecules are aligned in the horizontal direction (e.g., horizontal direction in FIG. 1B). The polarization direction of the polarized light that has passed the polarizing film 12a turns 90° due to the effect of the liquid crystals 14. Accordingly, the polarizing film 12b passes the polarized light without blocking. In this case, the user who watches the liquid crystal panel 1a may perceive the light. In other words, color of the liquid crystals 14 is white when a maximum voltage is applied to the liquid crystals 14. The voltage may range from zero (off) to the maximum voltage. In this case, the liquid crystals 14 are in a state in which the liquid crystals 14 are arranged between the vertical direction and a direction perpendicular to the vertical direction. That is, the liquid crystals 14 may be aligned in a diagonal direction that crosses both the vertical direction and the direction perpendicular to the vertical direction. In this state, the color of the liquid crystals 14 becomes gray. Accordingly, apart from black and white, intermediate gray scale may be represented by controlling the voltage applied to the liquid crystals 14 between off and the maximum voltage. In this manner, an image is displayed on the liquid crystal panel 1a.

In this case, a color filter may be used to display a color image.

The hard coating layer 15 is a layer to protect the liquid crystal panel 1a from damage. The hard coating layer 15 may be formed of a binder as a basic substance having e.g., a resin as a main component. A binder that is used for the low refractive layer 17, which will be described later, may be used as the binder of the hard coting layer 15.

In addition to the binder, metallic oxide particles may be included in the hard coating layer 15. The metallic oxide particles may include, for example, zirconium oxide, tin oxide, titanium oxide, cerium oxide, etc. The metallic oxide particles may enhance hard coating performance of the hard coating layer 15.

A conductive material may be included in the hard coating layer 15. The conductive material may include, for example, metal fine particles or a conductive polymer, or the like. Specifically, the conductive material may include, e.g., a antimony (Sn), phosphorus (P), or indium (In) doped tin oxide, an ion liquid containing fluorine anion or ammonium salt, a conductive polymer such as PEDOT/PSS, carbon nanotube, etc. The conductive material is not limited to one type, but two or more types of conductive materials may be included. The conductive material may reduce surface resistance of the hard coating layer 15, and thus may provide anti-static function to the hard coating layer 15.

The high refractive layer 16 may be arranged on or below the low refractive layer 17, and serve as a layer to further reduce reflectance.

The high refractive layer 16 may include a binder and high refractive particles. The high refractive layer 16 may be formed from e.g., a coating solution that contains a binder and high refractive particles. The high refractive layer 16 may be formed as a single layer or multiple layers. In an embodiment, the high refractive layer 16 may have a minimum number of layers as possible to reduce manufacturing costs.

To provide low reflection on the liquid crystal panel 1a, a refractive index of the high refractive layer 16 may be increased. Specifically, the refractive index of the high refractive layer 16 may be about 1.55 to about 1.80, and more desirably, about 1.60 to about 1.75.

An upper limit of a thickness of the high refractive layer 16 may be about 500 nm or less. It may be desirable that the upper limit of the thickness of the high refractive layer 16 is about 350 nm or less, and it may be more desirable that the upper limit of the thickness of the high refractive layer 16 is about 200 nm or less. A lower limit of the thickness of the high refractive layer 16 may be about 50 nm or less. It may be desirable that the lower limit of the thickness of the high refractive layer 16 is about 80 nm or less and it may be more desirable that the lower limit of the thickness of the high refractive layer 16 is about 100 nm or less.

The high refractive particles of the high refractive layer 16 may include, for example, zirconium oxide, hafnium oxide, tantalum oxide, titanium oxide, zinc oxide, aluminum oxide, magnesium oxide, tin oxide, yttrium oxide, barium titanate, antimony doped tin oxide (ATO), phosphorus doped tin oxide (PTO), indium doped tin oxide (ITO), zinc sulfide, etc. To provide durable stability, zirconium oxide, barium titanate, ATO, PTO, and ITO may be used as the high refractive particles of the high refractive layer 16.

An average particle size of primary particles (an average primary particle size) of the high refractive particles may be about 1 nm to about 200 nm. It may be desirable that the average primary particle size of the high refractive particles is about 3 nm to about 100 nm, and it may be more desirable that the average primary particle size of the high refractive particles is about 5 nm to about 50 nm.

The average primary particle size of the high refractive particles may be measured by phase observation of a particle dispersed liquid dried film using scanning electron microscope (SEM), transmission electron microscope (TEM), scanning transmission electron microscope (STEM), and the like.

The high refractive particles may undergo a dispersion stability process to have a suppressing cohesion. To perform the dispersion stability process, particles subject to surface processing may be used or a dispersant may be added. Alternatively, other particles with less surface charge quantity than the high refractive particles may be added.

Content of the high refractive particles may be about 20 to 500 parts by mass for 100 parts by mass of the binder. It may be desirable for the content of the high refractive particles to be about 50 to 400 parts by mass for 100 parts by mass of the binder, and more desirable to be about 100 to 300 parts by mass for 100 parts by mass of the binder.

A binder that is used for the low refractive layer 17, which will be described later, may be used as the binder of the high refractive layer 16. However, to reduce content of the high refractive particles, the refractive index of the binder of the high refractive layer 16 may be about 1.50 to 1.70.

The high refractive layer 16 may contain other components as needed, in addition to the binder and the high refractive particles. For example, the high refractive layer 16 may include an additive such as a polymerization initiator, a ultra violet (UV) absorber, a leveling agent, a surface active agent, or the like, and a dilute solvent. The surface state of the high refractive layer 16 may be controlled by adding e.g., the leveling agent or the surface active agent, and accordingly, performance of an upper layer of the high refractive layer 16 may be improved. In this case, the upper layer is, e.g., the low refractive layer 17.

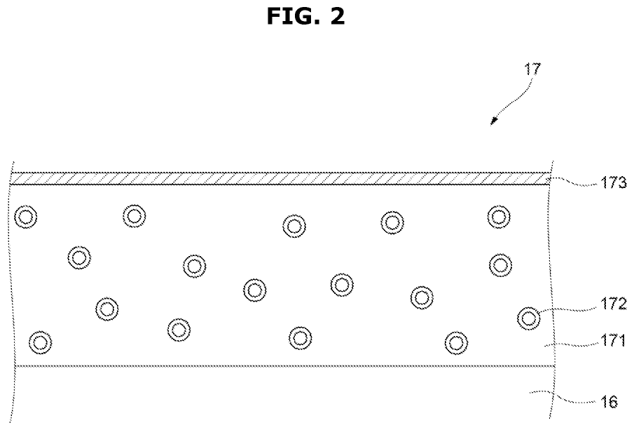

FIG. 2 shows a low refractive layer according to an embodiment.

In FIG. 2, an upper side of the low refractive layer 17 corresponds to a surface of the liquid crystal panel 1a, and a lower side of the low refractive layer 17 faces toward an inside of the liquid crystal panel 1a.

The low refractive layer 17 may be, for example, a resin film, which is a layer to reduce reflectance of the liquid crystal panel 1a.

The low refractive layer 17 may have a smaller refractive index than a refractive index of the high refractive layer 16. Specifically, the low refractive layer 17 may have a refractive index of about 1.20 to about 1.32. In this case, specular component included (SCI) reflectance Y, which will be described later, is about 0.3 or less. This may materialize the low reflective liquid crystal panel 1a. The low refractive layer 17 may be formed as a single layer or multiple layers. In an embodiment, the low refractive layer 17 may include a minimum number of layers as possible to reduce manufacturing costs. The low refractive layer 17 may have a thickness of about 50 nm to about 500 nm.

The low refractive layer 17 includes a binder 171 as a basic substance, and hollow silica particles 172 distributed in the binder 171. The low refractive layer 17 further includes a surface modifying agent 173 mainly distributed on the surface of the binder 171.

The binder 171 may have a web formation, and connect between the hollow silica particles 172. The binder 171 may include a resin as a primary component. The resin may include a fluorine resin. In this case, all or part of the resin included in the binder 171 may be the fluorine resin. The fluorine resin is a kind of resin that contains fluorine, e.g., polytetrafluoroethylene. In another example, the fluorine resin is perfluoroalkoxy alkanes (PFA). In yet another example, the fluorine resin is perfluorethylen-propylen (FEP) or ethylen-tetrafluorethylen (ETFE). The fluorine resin has a low refractive index. The use of the fluorine resin may make it easy for the low refractive layer 17 to have a lower refractive index, thereby further reducing the reflectance.

Furthermore, the fluorine resin may be desirably a photocurable fluorine resin. The photocurable fluorine resin is formed by photopolymerization of photopolymerized fluorinated monomers, expressed in the following general equations (1) and (2). For a structural unit M, about 0.1 mol % to about 100 mol % are contained. For a structural unit A, about 0 mol % to about 99.9 mol % (except 0 mol %) are contained. Furthermore, a number average molecular weight is about 30,000 to about 1,000,000.

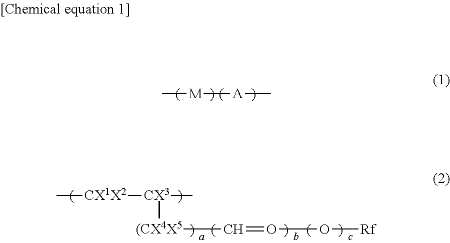

In the general equation (1), the structural unit M is a unit originated from a fluorinated ethylene monomer expressed in the general equation (2). The structural unit A is a unit originated from a monomer that may be polymerized with a fluorinated ethylene monomer expressed in the general equation (2).

In the general equation (2), X¹ and X² are H or F. Furthermore, X³ is H, F, CH₃ or CF₃. X⁴ and X⁵ are H, F or CF₃. Rf is an organyl group in which 1 or 3 Y's are bonded with a fluorinated alkyl group with 1 to 40 carbon atoms or a fluorinated alkyl group having ether bonding with 2 to 100 carbon atoms. Y¹ is a monovalent organyl group with 2 to 10 carbon atoms having ethylene C═C double bonding at an end. A is 0, 1, 2 or 3, and b and c are 0 or 1.

For the photopolymerized fluorine resin, OPTOOL AR-100 of Daikin Industries, Ltd., may be taken as an example.

The hollow silica particle 172 has a skin layer, and a cavity or a porous body is within the skin layer. The skin layer and the porous body may be primarily formed of silicon oxide (SiO₂). On the surface of the skin layer, there are multiple bondings of photopolymerizer and hydroxyl. The photopolymerizer and the skin layer are bonded by at least one of Si—O—Si bonding or hydrogen bonding. The photopolymerizer may include, for example, an acryloyl group or a methacryloyl group. That is, the hollow silica particles 172 include at least one of acryloyl groups or methacryloyl groups. The photopolymerizer is also referred to as ionizing radiation sclerosis. The hollow silica particles 172 may have at least the photopolymerizer, and the number or type of the photopolymerizer is not particularly limited.

An average primary particle size of the hollow silica particles 172 may be about 35 nm to about 100 nm. The average primary particle size of the hollow silica particles 172 may be desirably about 50 nm to about 85 nm. When the average primary particle size is less than about 35 nm, porosity of the hollow silica particle 172 tends to be small. Hence, it is difficult to gain an effect of reducing the refractive index of the low refractive layer 17. When central particle size exceeds about 100 nm, unevenness of the surface of the low refractive layer 17 becomes noticeable. Accordingly, anti-fouling or scratch resistance is easily degraded.

The average primary particle size of the hollow silica particles 172 may be measured in the same manner as for the high refractive layer 16. That is, the average primary particle size of the hollow silica particles 172 may be measured by phase observation of a particle dispersion liquid dry film using SEM, TEM, STEM, and the like.

A blending amount of the hollow silica particles 172 may be about 30 mass % to 65 mass % in the low refractive layer 17. When the blending amount of the hollow silica particles 172 is less than about 30 mass %, reflectance of the low refractive layer 17 tends to be high. When the blending amount of the hollow silica particles 172 exceeds about 65 mass %, film intensity tends to be reduced, and an extraneous material on the low refractive layer 17 is easily noticeable and hard to wipe out.

The hollow silica particles 172 may have a plurality of peak values on a frequency curve for particle sizes (particle size distribution curve) of the hollow silica particles 172. In other words, the hollow silica particles 172 may have a distribution of different particle sizes. For example, the hollow silica particles 172 with average primary particles sizes of about 30 nm, 60 nm, and 75 nm are selected, blended, and used.

The surface modifying agent 173 are mainly distributed on the surface of the binder 171 to modify the surface of the low refractive layer 17. The surface modifying agent 173 is segregated on the surface of the low refractive layer 17. Accordingly, the surface modifying agent 173 does not interfere with the function of the low refractive layer 17.

In an embodiment, the surface modifying agent 173 includes an oil repellent surface modifying agent and a lipophilic surface modifying agent.

The oil repellent surface modifying agent is blended in e.g., the binder 171 and segregated on the surface of the binder 171, thereby serving to improve an oil repellent property of the film surface of the low refractive layer 17. Effects of the oil repellent surface modifying agent may be identified by measuring a contact angle of e.g., an oleic acid on the film surface of the low refractive layer 17. In this case, the effect of the oil repellent surface modifying agent may be identified by a difference in contact angle of the film surface between the case where the oil repellent surface modifying agent is added in in the low refractive layer 17 and the case where of the oil repellent surface modifying agent is not added in the low refractive layer 17. In this regard, when the oil repellent surface modifying agent is used, the contact angle of the film surface increases. The difference in contact angle is desirably about 10° or more. The difference in contact angle is more desirably about 20° or more, and even more desirably about 30° or more.

The oil repellent surface modifying agent may be a fluorine compound having a photopolymerizer.

Specifically, the oil repellent surface modifying agent may be, for example, KY-1203 or KY-1207 of Shin-Etsu Chemical Co., Ltd. In another example, the oil repellent surface modifying agent may be OPTOOL DAC-HP of Daikin Industries, Ltd. In another example, the oil repellent surface modifying agent may be MEGAFACE F-477, F-554, F-556, F-570, RS-56, RS-75, RS-78, or RS-90 of DIC Co., Ltd. In another example, the oil repellent surface modifying agent may be FS-7024, FS-7025, FS-7026, FS-7031, or FS-7032 of FLUOROTECH Co., Ltd. In another example, the oil repellent surface modifying agent may be H-3593 or H-3594 of JEIL PHARMACEUTICAL CO., LTD. In another example, the oil repellent surface modifying agent may be SURECO AF Series of AGC Co., Ltd. In another example, the oil repellent surface modifying agent may be Ftergent F-222F, M-250, 601AD, or 601ADH2 of NEOS Co., Ltd.

The lipophilic surface modifying agent is blended in e.g., the binder 171 and segregated on the surface, thereby serving to improve lipophilicity of the film surface of the low refractive layer 17. Effects of the lipophilic surface modifying agent may be identified by measuring a contact angle of e.g., an oleic acid on the film surface of the low refractive layer 17. In this case, the effect of the lipophilic surface modifying agent may be identified by a difference in contact angle of the film surface between the case where the lipophilic surface modifying agent is added in the low refractive layer 17 and the case where the lipophilic surface modifying agent is not added in the low refractive layer 17. In this regard, when the lipophilic surface modifying agent is added, the contact angle decreases. The difference in contact angle is desirably about 3° or more. The difference in contact angle is more desirably about 5° or more, and even more desirably about 7° or more.

Specifically, the lipophilic surface modifying agent may include, for example, Melaqua 350L of Sanyo Hwaseong Industry Co., Ltd. In another example, the lipophilic surface modifying agent may be Ftergent 730LM, 602A, 650A, or 650AC of NEOS Co., Ltd.

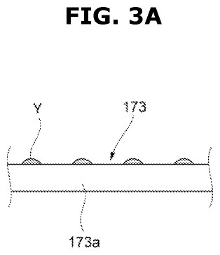

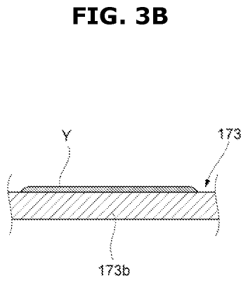

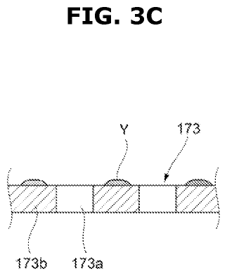

FIGS. 3A, 3B, and 3C show conceptual states of a surface modifying agent on a surface of a low refractive layer. In FIGS. 3A to 3C, an upper side of the surface modifying agent 173 corresponds to a surface of the liquid crystal panel 1a, and a lower side of the surface modifying agent 173 faces toward the inside of the liquid crystal panel 1a.

FIG. 3A shows an example in which an oil repellent surface modifying agent 173a is used and a lipophilic surface modifying agent 173b is not used. FIG. 3B shows an example in which the lipophilic surface modifying agent 173b is used and the oil repellent surface modifying agent 173a is not used. FIG. 3C shows an example in which both the oil repellent surface modifying agent 173a and the lipophilic surface modifying agent 173b are used. According to an embodiment, the low refractive layer 17 may have a surface state as shown in FIG. 3C according to an embodiment of the disclosure.

In FIG. 3A, the surface of the low refractive layer 17 is covered mainly with the oil repellent surface modifying agent 173a. In this case, for example, when an oily material Y sticks to the surface, wettability for the oil repellent surface modifying agent 173a is poor due to the presence of oil. That is, the oily material Y bounces off the oil repellent surface modifying agent 173a. As a result, the oily material Y tends to form into a bead shape. In this case, after the oily material Y is wiped out, an amount of the oily material Y staying on the surface is reduced. On the other hand, when the oily material Y sticks to the surface, the bead-shaped oily material Y may be seen with a naked eye and the stain tends to be noticeable.

In FIG. 3B, the surface of the low refractive layer 17 is covered mainly with the lipophilic surface modifying agent 173b. In this case, for example, when the oily material Y sticks to the surface, wettability for the lipophilic surface modifying agent 173b is good due to the presence of oil. As a result, the oily material Y tends to spread on the surface. In this case, the oily material Y is hard to wipe out or removed, and even after the oily material Y is wiped out, an amount of the oily material Y staying on the surface is not much reduced. On the other hand, when the oily material Y sticks to the surface, the spread oily material Y is hard to see with a naked eye and the stain is not easily noticeable.

In FIG. 3C, at least part of each of the oil repellent surface modifying agent 173a and the lipophilic surface modifying agent 173b is exposed on the surface of the binder 171. That is, the oil repellent surface modifying agent 173a and the lipophilic surface modifying agent 173b are both exposed on the surface of the binder 171. In this example, the oil repellent surface modifying agent 173a and the lipophilic surface modifying agent 173b are alternately distributed to cover the surface of the low refractive layer 17. Accordingly, the oil repellent surface modifying agent 173a and the lipophilic surface modifying agent 173b are alternately exposed on the surface of the low refractive layer 17. It may also be said that the oil repellent surface modifying agent 173a and the lipophilic surface modifying agent 173b are blended on the surface of the binder 171. In this case, when the low refractive layer 17 is viewed from the surface (e.g., viewed from above), one of the oil repellent surface modifying agents 173a and the lipophilic surface modifying agents 173b is distributed in a sea-like shape (e.g., covering a majority area of the surface), and the other is distributed in an island-like shape (e.g., sporadically distributed on the surface). However, it is not limited thereto. For example, the oil repellent surface modifying agent 173a and the lipophilic surface modifying agent 173b are alternately distributed in the form of strips.

In this case, for example, when the oily material Y sticks to the surface, wettability for the oil repellent surface modifying agent 173a is poor, but wettability for the lipophilic surface modifying agent 173b is good. As a result, the oily material Y spreads on the lipophilic surface modifying agent 173b and is easily distributed. However, it is difficult for the oily material Y to climb over the oil repellent surface modifying agent 173a. In this case, the oily material Y is easy to wipe out, and after the oily material Y is wiped out, an amount of the oily material Y staying on the surface is reduced. Furthermore, the oily material Y sticking to the surface is hard to see with a naked eye, so that the stain is not easily noticeable.

Moreover, when the fluorine resin is used for the resin of the binder 171, the lipophilic surface modifying agent 173b tends to be segregated on the surface of the low refractive layer 17. In the meantime, it is generally difficult for the oil repellent surface modifying agent 173a to be segregated on the surface of the low refractive layer 17. However, when both the oil repellent surface modifying agent 173a and the lipophilic surface modifying agent 173b are used, it is easier to segregate both the oil repellent surface modifying agent 173a and the lipophilic surface modifying agent 173b a on the surface of the low refractive layer 17. Accordingly, an amount of the oil repellent surface modifying agent 173a to be added in the low refractive layer 17 may be reduced.

A mass blending ratio (or mass ratio or mass mixing ratio) of the oil repellent surface modifying agent 173a to the lipophilic surface modifying agent 173b may be desirably about 0.05 to 20, that is, desirably ranges from 1:0.05 to 1:20. When there are too much of the oil repellent surface modifying agent 173a exceeding the above ratio range, the oily material Y greatly bounces off the oil repellent surface modifying agent 173a, and the oily material Y is not easily noticeable. However, the surface modifying agent is hardly segregated on the surface of the low refractive layer 17. That is, the surface modifying agent is hardly distributed on the surface. In the meantime, when there are too much of the lipophilic surface modifying agent 173b exceeding the above ratio range, the oily material Y is hardly wiped out on the surface. Accordingly, after an attempt to wipe out the oily material Y, a large amount of the oily material Y still stays on the surface.

It may be desirable that the oil repellent surface modifying agent 173a takes up a greater portion of the mass ratio than the lipophilic surface modifying agent 173b. Alternatively, the oil repellent surface modifying agent 173a and the lipophilic surface modifying agent 173b may occupy equal portions of the mass ratio. Specifically, it may be desirable that a mass blending ratio of the oil repellent surface modifying agent 173a to the lipophilic surface modifying agent 173b be about 1 to 20. In this case, the oily material Y is easy to wipe out, so that after the oily material Y is wiped out, an amount of the oily material Y staying on the surface is reduced. Furthermore, the oily material Y sticking to the surface is hard to see with a naked eye, so that the stain is not easily noticeable.

At least one of the oil repellent surface modifying agent 173a and the lipophilic surface modifying agent 173b may have a reactive group bonded with the resin contained in the binder 171. In an embodiment, the reactive group is a photopolymerizer, e.g., an acryloyl group and a methacryloyl group, and the binder 171 and the surface modifying agent are covalently bonded, making the bonding between them more secure. As a result, the low refractive layer 17 may maintain its function for a long time.

Furthermore, the low refractive layer 17 may include an additive to be used to form the low refractive layer 17.

In an embodiment, to form the low refractive layer 17, a photopolymerization initiator needs to initiate photopolymerization. Hence, the low refractive layer 17 includes the photopolymerization initiator as an additive. There are no particular limitations on the photopolymerization initiator. For example, a material that is hardly subject to oxygen inhibition and has better surface curability is desirable for the additive. Specifically, the additive may be, e.g., Omnirad127 of IGM Resins B. V. In another example, the additive may be IRGACURE127, IRGACURE819, or OXE-01 of BASF Japan Co., Ltd.

Furthermore, in an embodiment of the disclosure, an additive is used in a coating solution, which is used when the low refractive layer 17 is formed. Accordingly, the low refractive layer 17 also includes an additive to be used in the coating solution. This additive may be, e.g., a dispersant, antifoam, a UV absorber, a leveling agent, etc.

A method of manufacturing the low refractive layer 17 will now be described.

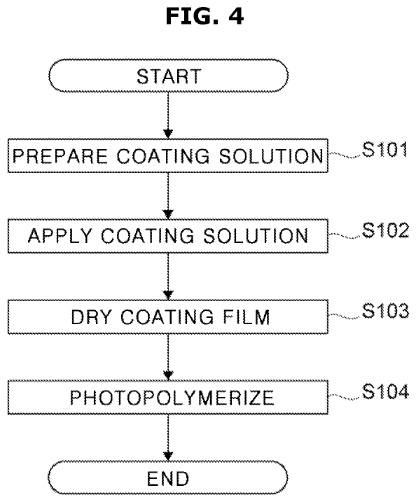

FIG. 4 is a flowchart illustrating a method of manufacturing a low refractive layer, according to an embodiment.

First, a coating solution is prepared to form the low refractive layer 17, in S101. The coating solution may be used for forming a resin film, which is included in the low refractive layer 17. The expression “the coating solution is prepared” as herein used implies providing the coating solution in various manners such as, for example, preparing the coating solution to be manufactured or preparing the coating solution via a purchase.

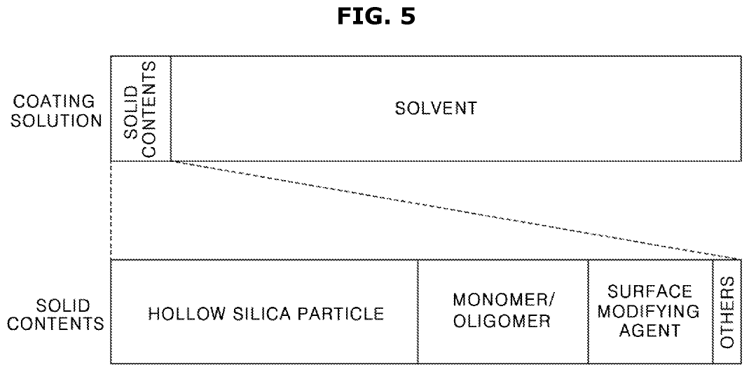

FIG. 5 shows components of a coating solution according to an embodiment.

The coating solution includes a solid content and a solvent. The solid content includes the hollow silica particles 172, a monomer and/or an oligomer, and the surface modifying agent 173. Accordingly, the coating solution includes the monomer and/or the oligomer, the hollow silica particles 172, the surface modifying agent 173, and the solvent. The coating solution may be made by putting the monomer and/or the oligomer, the hollow silica particles 72, and the surface modifying agent 173 into the solvent and agitating them. In this case, the solid content concentrations may be about 0.5 mass % to about 20 mass %. Among the solid content, the hollow silica particles 172 may amount to about 30 mass % to about 65 mass %. Furthermore, the concentration of the surface modifying agent 173 may be about 3 mass % to about 20 mass %.

The monomer and/or the oligomer may be a resin contained in the binder 171 by polymerization. In an embodiment of the disclosure, polymerization refers to photopolymerization. The monomer and/or the oligomer may now be referred to as a “binder component”. The binder component may become a fluorine resin when polymerized. Specifically, OPTOOL AR-100 of Daikin Industries, Ltd., Opstar JN35 of JAR Co., Ltd., LINC-162A or UA-306H of Kyoeisha Chemical Co., Ltd., KAYARAD PET-30 of Japan Explosives Co., Ltd., etc., may be used as the binder component.

Furthermore, the surface modifying agent 173 may include both the oil repellent surface modifying agent 173a and the lipophilic surface modifying agent 173b, as described above. The coating solution also contains a photopolymerization initiator. The coating solution may further contain the aforementioned dispersant, antifoam, UV absorber, leveling agent, etc.

The solvent disperses the binder component, the hollow silica particles 172, and the surface modifying agent 173. For the solvent, for example, methylene chloride, toluene, xylene, ethyl acetate, butyl acetate, or acetone may be used. In another example, methyl ethyl ketone (MEK), ethanol, methanol, or normal propyl alcohol may be used for the solvent. In another example, isopropyl alcohol, tert-butyl alcohol, mineral spirit, an oleic acid, or cyclohexanone may be used for the solvent. In still another example, N-methylpyrrolidone (NMP) or dimethyl phthalate (DMP) may further be used for the solvent.

Turning back to FIG. 4, a coating film is generated by applying the coating solution, in S102. A method of applying the coating solution is not particularly limited. In an example, a method including dropping the coating solution onto the high refractive layer 16 and applying the coating solution with a bar coater may be used. Alternatively, a method including dropping the coating solution onto the high refractive layer 16 and spinning the coating solution to form a membranous body with uniform thickness by the centrifugal force may be employed.

The oil repellent surface modifying agent 173a and the lipophilic surface modifying agent 173b may be segregated on the surface of the coating film.

The applied coating film is dried, in S103. Drying is a way to volatilize the solvent left at room temperature, but there may be other methods of forcedly getting rid of the solvent by heating or vacuum suction.

Subsequently, the binder component of the coating film is photopolymerized by irradiating light, such as UV. As a result, the binder component of the coating film is hardened into the binder 171, in S104. With the aforementioned processes, the low refractive layer 17 may be formed. The drying process and the polymerization process may be understood as a curing process to harden the applied coating solution.

In the meantime, the hard coating layer 15 and the high refractive layer 16 may also be made in the same processes as in operations S101 to S104. Specifically, in operation S101, a coating solution may be prepared for forming the hard coating layer 15 and/or the high refractive layer 16. In this case, the coating solution contains a binder component or a solvent. Furthermore, the coating solution may contain certain particles. Subsequently, an application process of operation S102, a drying process of operation S103, and a curing process of operation S104 are performed.

The low refractive layer 17 formed as described above makes an extraneous material that sticks to the low refractive layer 17 unnoticeable. The low refractive layer 17 also makes it easy to wipe out and remove the extraneous material. The same is true for the case where a large amount of the hollow silica particles 172 are contained in the low refractive layer 17.

In the above example, a case of forming the hard coating layer 15, the higher refractive layer 16, and the low refractive layer 17 on the liquid crystal panel of the display device 1 is illustrated. The embodiments are not, however, limited thereto, and the layers may be formed for other types of the display device such as, for example, an organic light emitting diode or a cathode ray tube (CRT).

Alternatively, the layers may be formed on the surface of a lens formed of glass or plastic. In this case, the lens is an example of a basic substance. Furthermore, a lens with the hard coating layer 15, the high refractive layer 16, and the low refractive layer 17 formed thereon is an example of an optical member. Moreover, a film formed of e.g., tri-acetyl cellulose (TAC) may be used as the basic substance. The aforementioned layers may be formed on this film. The film may be used as a low refractive film or an anti-reflective film. This is also an example of the optical member.

The hard coating layer 15, the high refractive layer 16, and the low refractive layer 17 may also be formed on the polarizing film 12, which is an example of a polarizing member, and may be used as a polarizing film.

Although the hard coating layer 15 or the high refractive layer 16 is provided in the above example, it is not necessary to provide these layers. That is, in an embodiment, one of the hard coating layer 15 and the high refractive layer 16 may not be provided. In another embodiment, both the hard coating layer 15 and the high refractive layer 16 may not be provided.

Although it is described that the binder component is polymerized by photopolymerization in the above example, the binder component may be polymerized by thermal polymerization.

### EMBODIMENTS

Additional embodiments of the disclosure will now be described in detail. The disclosure is not limited to the embodiments described herein and modifications can be made within the scope of the disclosure.

[Forming the High Refractive Layer 16]

First, a method of manufacturing the high refractive layer 16 will be described. Here, a coating solution of the high refractive layer 16 was made with the composition represented in Table 1 below.

### Embodiment A-1

A coating solution in Embodiment A-1 includes a binder component, i.e., a monomer and/or an oligomer, high refractive particles, a photopolymerization initiator, and a solvent. For the binder component, KAYARAD DPMA made of Japan Chemical Co., Ltd., was used. For the high refractive particles, zirconium oxide having an average primary particle size of about 10 nm was used. For the photopolymerization initiator, IRGACURE184 of BASF Japan Co., Ltd., was used. These components are solid contents, and the blending ratio is shown in Table 1.

The solid contents are thrown into a solvent, which is methyl isobutyl ketone, until reaching about 7 mass %, and then agitated. As such, the coating solution of the high refractive layer 16 was made.

The coating solution is applied on the hard coating layer 15 with a wire bar and made into a coating film. The coating film is left at room temperature for about 1 minute, and dried by heating it at about 100° C. for about 1 minute. Subsequently, a UV lamp (metal halogen lamp with light intensity of 1000 mJ/cm²) was used to irradiate light onto the coating film for 5 seconds. This may harden the coating film. With the aforementioned processes, the high refractive layer 16 was formed.

### Embodiment A-2

A coating solution in Embodiment A-2 is the same as the coating solution in Embodiment A-1 except for the following: for the high refractive particles, zirconium oxide having an average primary particle size of about 30 nm was used. For the solid content, a fluorine additive was added. For the fluorine additive, MEGAFACE F-568 of DIC Co., Ltd., was used. The blending ratio of Embodiment A-2 is the same as shown in Table 1.

### Embodiment A-3

A coating solution in Embodiment A-3 is the same as the coating solution in Embodiment A-2 except for the following: for the high refractive particles, antimony doped tin oxide having an average primary particle size of about 20 nm was used. The blending ratio of Embodiment A-3 is the same as shown in Table 1.

TABLE 1

| | | embodiment | embodiment | embodiment |
|---|---|---|---|---|
| classification | name of material | A-1 | A-2 | A-3 |
| binder component | KAYARAD DPHA | 27 | 28 | 18 |
| high refractive | zirconium oxide (average | 71 | | |
| particle | primary particle size 10 | | | |
| | nm) | | | |
| | zirconium oxide (average | | 68 | |
| | primary particle size 30 | | | |
| | nm) | | | |
| | antimony doped tin oxide | | | 78 |
| | (average primary particle | | | |
| | size 20 nm) | | | |
| | indium doped tin oxide | | | |
| | (average primary particle | | | |
| | size 20 nm) | | | |
| photopolymerization | IRGACURE 184 | 2 | 2 | 2 |
| initiator | | | | |
| others | MEGAFACE F-568 | | 2 | 2 |
| | total | 100 | 100 | 100 |
| solvent | Methyl isobutyl ketone | 100 | 100 | 100 |
| | solid content concentration | 7 | 7 | 7 |
| | (mass %) | | | |

※ unit is parts by mass

[Forming the Hard Coating Layer 15]

Subsequently, a method of manufacturing the hard coating layer 15 will be described. Here, a coating solution of the hard coating layer 15 was made with the composition represented in Table 2.

### Embodiment B-1

A coating solution in Embodiment B-1 includes a binder component, i.e., a monomer and/or an oligomer, a photopolymerization initiator, an anti-static agent, antifoam, and a solvent. For the binder component, UA-306T of Kyoeisha Chemical Co., Ltd., was used. For the binder component, VISCOAT #300 of Osaka organic chemical industry Co., Ltd., or KAYARAD PET-30 of Japan Explosives Co., Ltd., was also used. For the photopolymerization initiator, IRGACURE184 of BASF Japan Co., Ltd., was used. For the anti-static agent, NR-121X-9IPA of COLCOAT Co., Ltd., was used. For the antifoam, BYK-066N of ALTANA AG was used. These components are solid contents, and the blending ratio is the same as shown in Table 2.

The solid contents are thrown into a solvent, which is methyl isobutyl ketone, until reaching about 30 mass %, and then agitated. As such, the coating solution of the hard coating layer 15 was made.

The coating solution is applied on a substrate with a wire bar and made into a coating film. A TAC film was used for the substrate. The coating film is left at room temperature for about 1 minute, and dried by heating it at about 100° C. for about 1 minute. Subsequently, a UV lamp (metal halogen lamp with light intensity of 1000 mJ/cm²) was used to irradiate light onto the coating film for 5 seconds. This may harden the coating film. With the aforementioned processes, the hard coating layer 15 may be formed.

TABLE 2

| | | embodiment |
|---|---|---|
| classification | name of material | B-1 |
| binder component | UA-306T | 50 |
| | VISCOAT#300 | 20 |
| | KAYARAD PET-30 | 15 |
| photopolymerization | IRGACURE 184 | 4.95 |
| initiator | | |
| others | NR-121X-9IPA | 10 |
| | BYK-066N | 0.05 |
| | total | 100 |
| solvent | methyl ethyl ketone | 100 |
| | solid content concentration (mass %) | 40 |

※ unit is parts by mass

[Forming the Low Refractive Layer 17]

Next, a method of manufacturing the low refractive layer 17 will be described. Here, a coating solution of the low refractive layer 17 was made with the composition represented in Tables 3 to 5.

### Embodiment 1

A coating solution in Embodiment 1 includes a binder component, i.e., a monomer and/or an oligomer, and hollow silica particles 172. The coating solution contains the oil repellent surface modifying agent 173a and the lipophilic surface modifying agent 173b. The coating solution also contains a photopolymerization initiator and a solvent. For the binder component, OPTOOL AR-100 of Daikin Industries, Ltd., was used. The hollow silica particle 172 with an average primary particle size of 75 nm was used. For the oil repellent surface modifying agent 173a, KY-1203 of Shin-Etsu Chemical Co., Ltd., was used. For the lipophilic surface modifying agent 173b, Ftergent 650A of NEOS Co., Ltd., was used. For the photopolymerization initiator, IRGACURE127 of BASF Japan Co., Ltd., was used. These components are solid contents, and the blending ratio is the same as shown in Table 3.

The solid contents are thrown into the solvent, which is a mixed liquid of methyl isobutyl ketone and tert-butyl alcohol and then agitated. In this case, the solid content was 3.5 mass %. As such, the coating solution of the low refractive layer 17 was made. The mass blending ratio of the solvent is the same as shown in Table 3.

The coating solution is applied on the high refractive layer 16 with a wire bar and manufactured into a coating film. The high refractive layer 16 made according to Embodiment A-1 and the hard coating layer 15 made according to Embodiment B-1 were used.

The coating film is left at room temperature for about 1 minute, and dried by heating it at about 100° C. for about 1 minute. Subsequently, a UV lamp (metal halogen lamp with light intensity of 1000 mJ/cm²) was used to irradiate light onto the coating film for 5 seconds. This may harden the coating film. With the aforementioned processes, the low refractive layer 17 may be formed.

### Embodiment 2

In Embodiment 2, the mass blending ratio of the oil repellent surface modifying agent 173a to the lipophilic surface modifying agent 173b was changed from that of Embodiment 1. Specifically, as represented in Table 3, the mass blending ratio was 14.5/0.5=29. Other than this, the low refractive layer 17 was formed in the same way as in Embodiment 1.

### Embodiment 3

In Embodiment 3, the mass blending ratio of the oil repellent surface modifying agent 173a to the lipophilic surface modifying agent 173b was changed from that of Embodiment 1. Specifically, as represented in Table 3, the mass blending ratio was 7/8=0.875. In this case, the oil repellent surface modifying agent 173a takes up a less portion of the mass ratio than the lipophilic surface modifying agent 173b. Other than this, the low refractive layer 17 was formed in the same way as in Embodiment 1.

### Embodiment 4

In Embodiment 4, the oil repellent surface modifying agent 173a was changed from that of Embodiment 1. Specifically, the oil repellent surface modifying agent 173a was changed from KY-1203 of Shin-Etsu Chemical Co., Ltd., to MEGAFACE F-477 of DIC Co., Ltd. In this case, the former one has a difference in that it has photopolymerizer while the latter one does not. A case of having the photopolymerizer is expressed as “reactive group present” in Tables 3 to 5. Other than this, the low refractive layer 17 was formed in the same way as in Embodiment 1.

### Embodiment 5

In Embodiment 5, the lipophilic surface modifying agent 173b was changed from that of Embodiment 1. Specifically, the lipophilic surface modifying agent 173b was changed from Ftergent 650A of NEOS Co., Ltd., to Ftergent 730LM of the same company. In this case, there is a difference in that the former one has photopolymerizer while the latter one does not. Other than this, the low refractive layer 17 was formed in the same way as in Embodiment 1.

### Embodiment 6

In Embodiment 6, the oil repellent surface modifying agent 173a was changed from that of Embodiment 1. Specifically, the oil repellent surface modifying agent 173a was changed from KY-1203 of Shin-Etsu Chemical Co., Ltd., to MEGAFACE RS-90 of DIC Co., Ltd. In this case, there is a difference in that the former one is a fluorine compound with a photopolymerizer while the latter one is not a fluorine compound with the photopolymerizer. Other than this, the low refractive layer 17 was formed in the same way as in Embodiment 1.

### Embodiment 7

In Embodiment 7, the binder component was changed from that in Embodiment 1. Specifically, the binder component was changed from OPTOOL AR-100 of Daikin Industries, Ltd., to KAYARAD PET-30 of Japan Explosives Co., Ltd. In this case, the former one becomes a fluorine resin after photopolymerization. For example, fluorine is contained in the binder component, which is a monomer or an oligomer. This case is expressed as “contain F” in Tables 3 to 5. In this regard, there is a difference in that the latter one is not a fluorine resin after photopolymerization. Other than this, the low refractive layer 17 was formed in the same way as in Embodiment 1.

### Embodiment 8

In Embodiment 8, the hollow silica particles 172 were changed from those of Embodiment 1. Specifically, the hollow silica particles 172 were changed in the average primary particle size from about 75 nm to about 30 nm. Other than this, the low refractive layer 17 was formed in the same way as in Embodiment 1.

### Embodiments 9 to 13

In Embodiments 9 to 13, the binder component, the hollow silica particles 172, the surface modifying agent 173, the photopolymerization initiator, and the solvent were changed from those in Embodiment 1, as shown in Table 4. Except these changes, the low refractive layer 17 was formed in the same way as in Embodiment 1.

### Embodiments 14 to 16

In Embodiments 14 to 16, the high refractive layer 16 and the hard coating layer 15 were changed from those in Embodiment 1. The high refractive layer 16, made according to Embodiment A-2, was used in Embodiment 14. The high refractive layer 16, made according to Embodiment A-3, was used in Embodiment 15. In Embodiment 16, the high refractive layer 16 was not formed.

### Comparative Example 1

In the comparative example 1, the lipophilic surface modifying agent 173b was not used unlike in Embodiment 1. Specifically, only the oil repellent surface modifying agent 173a was used for the surface modifying agent.

### Comparative Examples 2 to 4

In the comparative examples 2 to 4, the binder component, the hollow silica particles 172, the surface modifying agent 173, and the solvent were changed from those in the comparative example 1, as shown in Table 5. Except these changes, the low refractive layer 17 was formed in the same way as in the comparative example 1. That is, the lipophilic surface modifying agent 173b was not used for the surface modifying agent.

TABLE 3

| | name of | | embodiment | embodiment | embodiment | embodiment |
|---|---|---|---|---|---|---|
| classification | material | specialty | 1 | 2 | 3 | 4 |
| bindercomponent | OPTOOL AR-100 | Contain F | 20 | 20 | 20 | 20 |
| | Opstar JN35 | Contain F | | | | |
| | LINC-162A | Contain F | 15 | 15 | 15 | 15 |
| | KAYARAD PET-30 | | | | | |
| | UA-306H | | | | | |
| hollow | Average primary | | 48 | 48 | 48 | 48 |
| silica | particle size 75 nm | | | | | |
| particle | Average primary | | | | | |
| | particle size 60 nm | | | | | |
| | Average primary | | | | | |
| | particle size 30 nm | | | | | |
| oil repellent | KY-1203 | reactive | 8 | 14.5 | 7 | |
| surface | | group | | | | |
| modifying | | present | | | | |
| agent | OPTOOL DAC-HP | reactive | | | | |
| | | group | | | | |
| | | present | | | | |
| | MEGAFACE RS-90 | reactive | | | | |
| | | group | | | | |
| | | present | | | | |
| | MEGAFACE F-477 | | | | | 8 |
| lipophilic | Ftergent 650A | reactive | 7 | 0.5 | 8 | 7 |
| surface | | group | | | | |
| modifying | | present | | | | |
| agent | Ftergent 602A | reactive | | | | |
| | | group | | | | |
| | | present | | | | |
| | Ftergent 730LM | | | | | |
| photopoly- | IRGACURE127 | | 2 | 2 | 2 | 2 |
| merization | IRGACURE819 | | | | | |
| initiator | IRGACUREOXE-01 | | | | | |
| | total | | 100 | 100 | 100 | 100 |
| solvent | Methyl isobutyl ketone | | 20 | 20 | 20 | 20 |
| | Tert-butyl alcohol | | 80 | 80 | 80 | 80 |
| | cyclohexanone | | | | | |
| | solid content | | 3.5 | 3.5 | 3.5 | 3.5 |
| | concentration | | | | | |
| | (mass %) | | | | | |
| other layers | High refractive layer | | A-1 | A-1 | A-1 | A-1 |
| | Hard coating layer | | B-1 | B-1 | B-1 | B-1 |
| estimation | reflectance | SCI Y | 0.12 | 0.12 | 0.13 | 0.13 |
| results | | value | | | | |
| | Fingerprint | Decision | A | B | B | B |
| | wipeability | levels | | | | |
| | test | A to D | | | | |
| | Oil pen test | Decision | A | A | B | B |
| | | levels | | | | |
| | | A to D | | | | |
| | Scratch | Decision | A | A | B | B |
| | resistance | levels | | | | |
| | test | A to D | | | | |
| | name of | | embodiment | embodiment | embodiment | embodiment |
| classification | material | specialty | 5 | 6 | 7 | 8 |
| bindercomponent | OPTOOL AR-100 | Contain F | 20 | 20 | | 20 |
| | Opstar JN35 | Contain F | | | | |
| | LINC-162A | Contain F | 15 | 15 | 15 | 15 |
| | KAYARAD PET-30 | | | | 20 | |
| | UA-306H | | | | | |
| hollow | Average primary | | 48 | 48 | 48 | |
| silica | particle size 75 nm | | | | | |
| particle | Average primary | | | | | |
| | particle size 60 nm | | | | | |
| | Average primary | | | | | 48 |
| | particle size 30 nm | | | | | |
| oil repellent | KY-1203 | reactive | 8 | | 8 | 8 |
| surface | | group | | | | |
| modifying | | present | | | | |
| agent | OPTOOL DAC-HP | reactive | | | | |
| | | group | | | | |
| | | present | | | | |
| | MEGAFACE RS-90 | reactive | | 8 | | |
| | | group | | | | |
| | | present | | | | |
| | MEGAFACE F-477 | | | | | |
| lipophilic | Ftergent 650A | reactive | | 7 | 7 | 7 |
| surface | | group | | | | |
| modifying | | present | | | | |
| agent | Ftergent 602A | reactive | | | | |
| | | group | | | | |
| | | present | | | | |
| | Ftergent 730LM | | 7 | | | |
| photopoly- | IRGACURE127 | | 2 | 2 | 2 | 2 |
| merization | IRGACURE819 | | | | | |
| initiator | IRGACUREOXE-01 | | | | | |
| | total | | 100 | 100 | 100 | 100 |
| solvent | Methyl isobutyl ketone | | 20 | 20 | 20 | 20 |
| | Tert-butyl alcohol | | 80 | 80 | 80 | 80 |
| | cyclohexanone | | | | | |
| | solid content | | 3.5 | 3.5 | 3.5 | 3.5 |
| | concentration | | | | | |
| | (mass %) | | | | | |
| other layers | High refractive layer | | A-1 | A-1 | A-1 | A-1 |
| | Hard coating layer | | B-1 | B-1 | B-1 | B-1 |
| estimation | reflectance | SCI Y | 0.13 | 0.13 | 0.30 | 0.41 |
| results | | value | | | | |
| | Fingerprint | Decision | B | B | B | A |
| | wipeability | levels | | | | |
| | test | A to D | | | | |
| | Oil pen test | Decision | B | B | A | A |
| | | levels | | | | |
| | | A to D | | | | |
| | Scratch | Decision | B | A | A | A |
| | resistance | levels | | | | |
| | test | A to D | | | | |

※ unit is parts by mass

TABLE 4

| | name of | | embodiment | embodiment | embodiment | embodiment |
|---|---|---|---|---|---|---|
| classification | material | specialty | 9 | 10 | 11 | 12 |
| | OPTOOL AR-100 | Contain F | | 30 | | 15 |
| binder- | Opstar JN35 | contain F | 25 | | 10 | |
| component | | | | | | |
| | LINC-162A | contain F | | 5 | 25 | 20 |
| | KAYARAD PET-30 | | 10 | | | |
| | UA-306H | | | | | |
| hollow | Average primary | | 48 | | 10 | |
| silica | particle size 75 nm | | | | | |
| particles | Average primary | | | 50 | 33 | 48 |
| | particle size 60 nm | | | | | |
| | Average primary | | | | 5 | |
| | particle size 30 nm | | | | | |
| oil repellent | KY-1203 | reactive | | | 12 | |
| surface | | group | | | | |
| modifying | | present | | | | |
| agent | OPTOOL DAC-HP | reactive | 10 | 10 | | 10 |
| | | group | | | | |
| | | present | | | | |
| | MEGAFACE RS-90 | reactive | | | | |
| | | group | | | | |
| | | present | | | | |
| | MEGAFACE F-477 | | | | | |
| lipophilic | Ftergent 650A | reactive | | 3 | 3 | |
| surface | | group | | | | |
| modifying | | present | | | | |
| agent | Ftergent 602A | reactive | 5 | | | 5 |
| | | group | | | | |
| | | present | | | | |
| | Ftergent 730LM | | | | | |
| photopoly- | IRGACURE127 | | | 2 | | |
| merization | IRGACURE819 | | 2 | | | 2 |
| initiator | IRGACUREOXE-01 | | | | 2 | |
| | total | | 100 | 100 | 100 | 100 |
| solvent | Methyl isobutyl ketone | | 20 | 20 | 20 | 90 |
| | Tert-butyl alcohol | | 80 | 80 | 80 | |
| | cyclohexanone | | | | | 10 |
| | solid content | | 3.5 | 3.5 | 3.5 | 3.5 |
| | concentration | | | | | |
| | (mass %) | | | | | |
| other layers | High refractive layer | | A-1 | A-1 | A-1 | A-1 |
| | Hard coating layer | | B-1 | B-1 | B-1 | B-1 |
| estimation | reflectance | SCIY | 0.20 | 0.19 | 0.19 | 0.14 |
| results | | value | | | | |
| | Fingerprint | Decision | A | A | A | A |
| | wipeability | levels | | | | |
| | test | A to D | | | | |
| | Oil pen test | Decision | A | A | A | A |
| | | levels | | | | |
| | | A to D | | | | |
| | Scratch | Decision | A | A | A | A |
| | resistance | levels | | | | |
| | test | A to D | | | | |
| | name of | | embodiment | embodiment | embodiment | embodiment |
| classification | material | specialty | 13 | 14 | 15 | 16 |
| | OPTOOL AR-100 | Contain F | 20 | 20 | | 20 |
| binder- | Opstar JN35 | contain F | | | 20 | |
| component | | | | | | |
| | LINC-162A | contain F | 15 | 15 | 10 | 15 |
| | KAYARAD PET-30 | | | | 5 | |
| | UA-306H | | | | | |
| hollow | Average primary | | 48 | 48 | | 48 |
| silica | particle size 75 nm | | | | | |
| particles | Average primary | | | | 50 | |
| | particle size 60 nm | | | | | |
| | Average primary | | | | | |
| | particle size 30 nm | | | | | |
| oil repellent | KY-1203 | reactive | 12 | 12 | | 12 |
| surface | | group | | | | |
| modifying | | present | | | | |
| agent | OPTOOL DAC-HP | reactive | | | 10 | |
| | | group | | | | |
| | | present | | | | |
| | MEGAFACE RS-90 | reactive | | | | |
| | | group | | | | |
| | | present | | | | |
| | MEGAFACE F-477 | | | | | |
| lipophilic | Ftergent 650A | reactive | 3 | 3 | 3 | 3 |
| surface | | group | | | | |
| modifying | | present | | | | |
| agent | Ftergent 602A | reactive | | | | |
| | | group | | | | |
| | | present | | | | |
| | Ftergent 730LM | | | | | |
| photopoly- | IRGACURE127 | | 2 | 2 | 2 | 2 |
| merization | IRGACURE819 | | | | | |
| initiator | IRGACUREOXE-01 | | | | | |
| | total | | 100 | 100 | 100 | 100 |
| solvent | Methyl isobutyl ketone | | 20 | 20 | 80 | 20 |
| | Tert-butyl alcohol | | 80 | 80 | 10 | 80 |
| | cyclohexanone | | | | 10 | |
| | solid content | | 3.5 | 3.5 | 3.5 | 3.5 |
| | concentration | | | | | |
| | (mass %) | | | | | |
| other layers | High refractive layer | | A-1 | A-2 | A-3 | — |
| | Hard coating layer | | B-1 | B-1 | B-1 | B-1 |
| estimation | reflectance | SCIY | 0.12 | 0.15 | 0.20 | 0.29 |
| results | | value | | | | |
| | Fingerprint | Decision | A | A | A | A |
| | wipeability | levels | | | | |
| | test | A to D | | | | |
| | Oil pen test | Decision | A | A | A | A |
| | | levels | | | | |
| | | A to D | | | | |
| | Scratch | Decision | A | A | A | A |
| | resistance | levels | | | | |
| | test | A to D | | | | |

※ unit is parts by mass

TABLE 5

| | name of | | Comparative | Comparative | Comparative | Comparative |
|---|---|---|---|---|---|---|
| classification | material | specialty | example 1 | example 2 | example 3 | example 4 |
| binder | OPTOOL AR-100 | contain F | 20 | | | |
| component | | | | | | |
| | Opstar JN35 | contain F | | 20 | 25 | |
| | LINC-162A | contain F | 15 | 15 | | 15 |
| | KAYARAD PET-30 | | | | 10 | 20 |
| | UA-306H | | | | | |
| hollow | Average primary | | 48 | | 48 | 48 |
| silica | particle size 75 nm | | | | | |
| particles | Average primary | | | 50 | | |
| | particle size 60 nm | | | | | |
| | Average primary | | | | | |
| | particle size 30 nm | | | | | |
| oil repellent | KY-1203 | reactive | 15 | | | 15 |
| surface | | group | | | | |
| modifying | | present | | | | |
| agent | OPTOOL DAC-HP | reactive | | 13 | | |
| | | group | | | | |
| | | present | | | | |
| | MEGAFACE RS-90 | reactive | | | 15 | |
| | | group | | | | |
| | | present | | | | |
| | MEGAFACE F-477 | | | | | |
| lipophilic | Ftergent 650A | reactive | | | | |
| surface | | group | | | | |
| modifying | | present | | | | |
| agent | Ftergent 602A | reactive | | | | |
| | | group | | | | |
| | | present | | | | |
| | Ftergent 730LM | | | | | |
| photopoly- | IRGACURE127 | | 2 | 2 | 2 | 2 |
| merization | IRGACURE819 | | | | | |
| initiator | IRGACUREOXE-01 | | | | | |
| | total | | 100 | 100 | 100 | 100 |
| solvent | Methyl isobutyl ketone | | 20 | 20 | 90 | 20 |
| | Tert-butyl alcohol | | 80 | 80 | | 80 |
| | cyclohexanone | | | | 10 | |
| | solid content | | 3.5 | 3.5 | 3.5 | 3.5 |
| | concentration | | | | | |
| | (mass %) | | | | | |
| other layers | High refractive layer | | A-1 | A-1 | A-1 | A-1 |
| | Hard coating layer | | B-1 | B-1 | B-1 | B-1 |
| estimation | reflectance | SCI Y | 0.12 | 0.16 | 0.19 | 0.29 |
| results | | value | | | | |
| | Fingerprint | Decision | D | D | D | D |
| | wipeability | levels | | | | |
| | test | A to D | | | | |
| | Oil pen test | Decision | C | C | D | C |
| | | levels | | | | |
| | | A to D | | | | |
| | Scratch | Decision | B | C | D | C |
| | resistance | levels | | | | |
| | test | A to D | | | | |

※ unit is parts by mass

[Estimation]

SCI reflectance Y was measured for Embodiments 1 to 16 and the comparative examples 1 to 4. Also, fingerprint wipeability test, oil pen test, and scratch resistance test were performed.

The SCI reflectance Y was measured using CM-2600d of Konica Minolta, Inc. The measurement was performed after a black polyester (PET) film is attached to the rear side of the film to be measured. The smaller the SCI reflectance Y is, the better the result is. When the SCI reflectance Y is 0.3 or less, the test was decided to pass. For less than 0.2 of the SCI reflectance Y, the test was decided to have a better result.

The fingerprint wipeability test was performed by applying a fingerprint on the surface of the low refractive layer 17 and estimating wipeability in four levels A to D at a time when the fingerprint is wiped out. In this test, the more easily the fingerprint is wiped out, the better the result is. A level near D means that the wipeability is poor, indicating that it is difficult to wipe out the fingerprint. For the estimation levels A and B, the test was decided to pass, and for the estimation levels C and D, the test was decided to fail.

The oil pen test was performed by estimating whether ink of an oil pen is bounced off from the surface of the low refractive layer 17 in levels A to D when drawing a picture with the oil pen on the surface of the low refractive layer 17. In this test, the further the ink is bounced off from the surface, the better the estimation is. A level near D means that the ink is hardly bounced off but easily stuck onto the surface. For the estimation levels A and B, the test was decided to pass, and for the estimation levels C and D, the test was decided to fail.

The scratch resistance test was performed by scratching the surface of the low refractive layer 17 with steel wool and estimating whether a damage occurs on the surface in levels A to D. In this test, the lower the damage occurrence is, the better the result is. A level near D means that the surface is damaged more easily. For the estimation levels A and B, the test was decided to pass, and for the estimation levels C and D, the test was decided to fail.

Embodiments 1 to 16 and the comparative examples 1 to 4 are compared with one another and the estimations are represented in Tables 3 to 5.

First, for the SCI reflectance Y, all of Embodiments 1 to 16 and the comparative examples 1 to 4 passed.

For the fingerprint wipeability test and the oil pen test, all of Embodiments 1 to 16 passed but all of the comparative examples 1 to 4 failed.

For the scratch resistance test, Embodiments 1 to 16 and the comparative example 1 passed and the comparative examples 2 to 4 failed.

To sum up, all of Embodiments 1 to 16 passed for all the tests. In Embodiments 1 to 16, both the oil repellent surface modifying agent 173a and the lipophilic surface modifying agent 173b were used. On the other hand, the comparative examples 1 to 4 failed for at least one of the tests. In the comparative examples 1 to 4, the lipophilic surface modifying agent 173b was not used.

Among Embodiments 1 to 16, Embodiments 1 and 9 to 16 particularly had better results. All of Embodiments 1 and 9 to 16 satisfy the following conditions:

(1) A mass blending ratio of the oil repellent surface modifying agent 173a to the lipophilic surface modifying agent 173b is about 0.05 to 20.

(2) The oil repellent surface modifying agent 173a takes up a greater portion of the mass ratio than the lipophilic surface modifying agent 173b.

(3) At least one of the oil repellent surface modifying agent 173a and the lipophilic surface modifying agent 173b has a reactive group to be bonded with a resin of the binder 171.

(4) The oil repellent surface modifying agent 173a is a fluorine compound having a photopolymerizer.

(5) The resin of the binder 171 includes a fluorine resin.

(6) an average primary particle size of the hollow silica particle 172 is about 35 nm to about 100 nm.

While embodiments of the disclosure have been particularly shown and described, it will be understood that various changes in form and details may be made therein without departing from the spirit and scope of the following claims.

What is claimed is:

1. A display device comprising:
a display panel configured to display an image; and
a low refractive layer formed on a surface of the display panel,
wherein the low refractive layer comprises:
a basic substance;
hollow silica particles provided in the basic substance; and
a surface modifying agent provided on a surface of the basic substance, the surface modifying agent including an oil repellent surface modifying agent and a lipophilic surface modifying agent.

2. The display device of claim 1, wherein a mass mixing ratio of the oil repellent surface modifying agent to the lipophilic surface modifying agent is about 0.05 to about 20.

3. The display device of claim 1, wherein a mass mixing ratio of the oil repellent surface modifying agent to the lipophilic surface modifying agent is about 1 to about 20.

4. The display device of claim 1, wherein the basic substance comprises a binder including a resin formed by polymerizing a monomer or an oligomer.

5. The display device of claim 1, wherein at least one of the oil repellent surface modifying agent or the lipophilic surface modifying agent includes a reactive group, which is to be bonded with a resin included in the basic substance.

6. The display device of claim 1, wherein at least one of the oil repellent surface modifying agent or the lipophilic surface modifying agent includes a fluorine compound having a photopolymerizer.

7. The display device of claim 6, wherein the photopolymerizer comprises an acrylol group or a methacryloyl group.

8. The display device of claim 1, wherein the basic substance comprises a fluorine resin.

9. The display device of claim 1, wherein an average primary particle size of the hollow silica particles is about 35 nm to about 100 nm.

10. A resin film comprising:
a basic substance;
hollow silica particles provided in the basic substance; and
a surface modifying agent including an oil repellent surface modifying agent and a lipophilic surface modifying agent.

11. The resin film of claim 10, wherein a mass mixing ratio of the oil repellent surface modifying agent to the lipophilic surface modifying agent is about 0.05 to about 20.

12. The resin film of claim 10, wherein a mass mixing ratio of the oil repellent surface modifying agent to the lipophilic surface modifying agent is about 1 to about 20.

13. The resin film of claim 10, wherein the oil repellent surface modifying agent and the lipophilic surface modifying agent are provided on a surface of the basic substance.

14. The resin film of claim 10, wherein the basic substance comprises a binder including a resin formed by polymerizing a monomer or an oligomer.

15. The resin film of claim 10, wherein at least one of the oil repellent surface modifying agent or the lipophilic surface modifying agent includes a reactive group, which is to be bonded with a resin included in the basic substance.

16. The resin film of claim 10, wherein at least one of the oil repellent surface modifying agent or the lipophilic surface modifying agent includes a fluorine compound having a photopolymerizer.

17. The resin film of claim 16, wherein the photopolymerizer comprises an acrylol group or a methacryloyl group.

18. The resin film of claim 10, wherein at least a portion of the oil repellent surface modifying agent and at least a portion of the lipophilic surface modifying agent are exposed on a surface of the basic substance.

19. The resin film of claim 10, wherein the basic substance comprises a fluorine resin.

20. The resin film of claim 10, wherein an average primary particle size of the hollow silica particles is about 35 nm to about 100 nm.
